(19) United States
(12) Patent Application Publication
(10) Pub. No.: US 2012/0039760 A1
(43) Pub. Date: Feb. 16, 2012

(54) Hermetic Container for Thermal Conversion Reaction

(75) Inventors: Soon Kwang Youn, Seoul (KR); Jae Chul Jung, Daejeon (KR); Tae Soo Kim, Seoul (KR); Tae Hyung Kim, Gyeonggi-do (KR); Sun II You, Incheon (KR); Kyung Ho Kim, Daejeon (KR)

(73) Assignees: HANKOOK SILICON CO., LTD., Gyeonggi-do (KR); SUSUNGTECH CO., LTD., Chungcheongnam-do (KR)

(21) Appl. No.: 13/257,034

(22) PCT Filed: Mar. 18, 2010
(86) PCT No.: PCT/KR2010/001686

§ 371 Date: Oct. 26, 2011

(30) Foreign Application Priority Data
Mar. 20, 2009 (KR) 10-2009-0023875
Apr. 1, 2009 (KR) 10-2009-0027973

(51) Int. Cl. B01J 19/26

(52) U.S. Cl. 422/198

(57) ABSTRACT

Disclosed is a hermetic container for thermal conversion reaction, including: a base plate in which utilities are installed; a vessel which, together with the base plate, forms a hermetic hot zone; a heater which is arranged in the hot zone; inlet and outlet holes through which reaction gas is supplied to and discharged from the hot zone; and a heat exchanger which is provided inside the vessel so that the reaction gas supplied to the hot zone via the inlet holes can absorb thermal energy transferred to the vessel to cool temperature of the vessel and at the same time be supplied to the hot zone as being heated. With this, when the reaction gas is supplied to the hot zone via the heat exchanger provided inside the vessel, the thermal energy transferred from the heater of the hot zone to the vessel and escaping outward is absorbed by the reaction gas supplied to the hot zone, thereby preventing the vessel from being heated at a limit temperature or over. Further, the reaction gas absorbing the thermal energy escaping to the outside of the vessel is heated and then supplied to the hot zone, thereby reducing power consumption of the heater.

### BACKGROUND OF THE INVENTION

(a) Field of the Invention

The present invention relates to a hermetic container for thermal conversion reaction, and more particularly to a hermetic container for thermal conversion reaction, in which reaction gas is supplied to an inside of a hot zone as it is heated by absorbing thermal energy escaping outward via a vessel, thereby preventing the vessel from being heated at a limit temperature or over, and reducing power consumption of a heater for maintaining an inner temperature of the hot zone.

(b) Description of the Related Art

Hitherto, solar grade silicon has been generally acquired from a surplus material of a semiconductor industry. However, some manufacturers of semiconductor grade silicon commercially produce a solar grade material through typical processes. One of the typical processes converts metallurgical silicon into one of silane, polysilane and chlorosilane compounds. Silane, polysilane or chlrorosilane is pyrolyzed in a Siemens-type reactor and forms highgrade purity polysilicon.

In such a Siemens-type process, a polysilicon rod is manufactured by pyrolysis of a gaseous silicon compound, e.g., silane, polysilane or chloro silane on a filament substrate so-called a slim rod. The slim rod is generally manufactured with highgrade purity polysilicon in order to secure a level of product purity.

As above, while producing polycrystalline silicon by reacting trichlorosilane (SiHCl₃, hereinafter referred to as ‘TCS’) with hydrogen in a reactor, plenty of silicon tetrachloride (SiCl₄, hereinafter referred to as ‘STC’) is acquired during participation of polycrystalline silicon.

STC mixed with hydrogen (H₂) is reduced by thermal hydrogenation into TCS and then reused.

FIG. 1 is a cross-sectional view of a conventional converter that converts STC into TCS through thermal conversion. As shown therein, in the conventional converter, a heater 13 is arranged on a top of a base plate 10, and a bell-curve or bell-jar type vessel 20 for forming a hot zone 21 is assembled to an upper side of the base plate 10. Further, a shield 40 is installed between the heater 13 and the vessel 20 so as to prevent internal heat of the hot zone 21 from being transferred to the vessel 20 and escaping outward.

In such an assembled state, if the heater 13 is powered on and heats the hot zone 21 to have an inner temperature of about 900° C. to 1500° C. while supplying mixed gas of STC and H₂ (hereinafter, referred to as ‘reaction gas’) to the hot zone 21 through an inlet hole 11 formed on the base plate 10, the reaction gas within the hot zone 21 is converted into TCS and hydrogen chloride (HCl) by hydrogenation at high temperature and discharged through an outlet hole 12.

The vessel 20 surrounding the hot zone 21 is a metallic structural frame, in which carbon steel and stainless steel form a cladding structure. Since the vessel 20 is decreased in stiffness for the structural frame when heated at a temperature of about 500° C. or over, a cooling jacket 31 in which cooling water circulates is arranged on an outside of the vessel 20, thereby maintaining the vessel 20 at a temperature of 300° C. or under,

In other words, the hot zone 21 is configured to keep high temperature proper to cause thermal conversion reaction of the reaction gas, while the vessel 20 surrounding the hot zone 21 is configured to have a separate cooling system 30 for structural stability. However, such a conventional configuration has low efficiency of thermal energy utilization since a lot of thermal energy escapes outward via the vessel 20. Also, because the heater 13 has to additionally operate as much as loss of thermal energy transferred from the hot zone to the vessel, there is a problem of increasing power consumption.

Also, the reaction gas (STC+H₂) is supplied at high pressure through a plurality of inlet holes 11 formed in the center and outer circumference of the base plate 10 so that it can evenly circulate and cause the reaction within the hot zone 21. At this time, the temperature of supplied reaction gas corresponds to an evaporation temperature of STC depending on supply pressure, and therefore a lot of thermal energy is needed for maintaining the hot zone 21 to have a temperature of about 900° C. to 1500° C.

Also, the cooling system 30 needs a cooling water circulating unit 32 for circulating cooling water to the cooling jacket 31 provided on the outside of the vessel 20, a cooling unit 33 for cooling the cooling water increased in temperature while cooling the vessel 20 again through the cooling jacket 31, and a tank and the like units for storing the cooling water, which are installed in the vicinity of a conversion apparatus. Accordingly, the cooling system 30 together with complicated piping occupies a large space, and the power consumption increases to drive a pump and the like units for circulating the cooling water. Also, enormous investment costs of establishing and managing the cooling system 30 increase.

### SUMMARY OF THE INVENTION

Accordingly, the present invention is conceived to solve the forgoing problems, and an aspect of the present invention is to provide a hermetic container for thermal conversion reaction, in which a vessel is prevented from being heated at a limit temperature or over, and thus there is no need of a separate cooling system for cooling the vessel since reaction gas is supplied to a hot zone as it is heated by absorbing thermal energy escaping to the outside of the vessel when the reaction gas is supplied to the hot zone.

Another aspect is to provide a hermetic container for thermal conversion reaction, in which the reaction gas is supplied to the hot zone as it is heated by absorbing thermal energy, so that not only the temperature of the hot zone can be prevented from being rapidly lowered, but also power consumption of a heater can be reduced.

Still another aspect is to provide a hermetic container for thermal conversion reaction, in which a plurality of partition walls constituting a heat exchanger and a circulating passage connecting an inlet hole with the hot zone through a through hole formed in one end part or the other end part of the partition wall are arranged in a zigzag fashion, thereby enhancing a thermal exchanging efficiency.

Still another aspect is to provide a hermetic container for thermal conversion reaction, in which a spraying nozzle is provided for dispersing spraying pressure of reaction gas at a gas inlet side of the circulating passage connecting the inlet hole and the hot zone and at the same time evenly supplying the reaction gas up to a region between the spraying nozzle and another spraying nozzle adjacent thereto.

Still another aspect is to provide a hermetic container for thermal conversion reaction, in which heat exchange is carried out even in regions between plural spraying nozzles and a lower region of the circulating passage where the spraying nozzle is placed, thereby improving efficiency of heat exchange.

According to an exemplary embodiment, there is provided a hermetic container for thermal conversion reaction, including: a base plate; a vessel which, together with the base plate, forms a hermetic hot zone; a heater which is arranged in the hot zone; inlet and outlet holes through which reaction gas is supplied to and discharged from the hot zone; and a heat exchanger which is provided inside the vessel so that the reaction gas supplied to the hot zone via the inlet holes can absorb thermal energy transferred to the vessel to cool temperature of the vessel and at the same time be supplied to the hot zone as being heated.

The heat exchanger may include a circulating passage that circulates in a space between the vessel and the hot zone and connects the inlet holes and the hot zone.

The circulating passage may include a partition wall partitioning a space involving the inlet holes and adjacent to an inside of the vessel and a space involving the heater and the outlet holes, and a through hole formed on the partition wall as being spaced apart from the inlet hole so that the reaction gas supplied via the inlet hole can be supplied to the hot zone after exchanging heat while circulating in a space between the partition wall and the vessel).

The partition wall may be provided as two or more cylindrical shapes different in size so that a space between the space involving the inlet hole and adjacent to the inside of the vessel and the space involving the heater and the outlet hole can be partitioned into a plurality of layers, and is arranged such that a small partition wall is inserted in a large partition wall.

The through holes formed on the two or more partition walls may be alternately arranged with respect to the inlet hole to change a moving path of the reaction gas.

The partition wall may be shaped like a cylinder having an opened top, and the hermetic container further includes a cover finishing the tops of the partition walls and having an outer circumference adhered to the inside of the vessel.

The partition wall may include a material having thermal resistance to temperature raised by thermal energy transferred from the hot zone at a arranged position.

The hermetic container further include a spraying nozzle provided at a gas discharging side of the inlet hole and dispersing gas supplied to the heat exchanger.

The plural inlet holes may be formed at predetermined intervals on the base plate corresponding to a region between the partition wall and the vessel.

The spraying nozzle may include one end part connected to the inlet hole and receiving gas, and the other end part including a finished supply pipe, and at least one spraying hole laterally formed from the supplying pipe and discharging gas.

The spraying nozzle may include a guide spaced apart from the spraying hole and guiding the laterally sprayed gas to be induced downward.

The spraying nozzle may include one end part connected to the inlet hole and receiving gas, and the other end part including a finished supply pipe, and at least one spraying hole inclined downward from the supplying pipe and discharging gas.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a cross-sectional view of a conventional converter that converts STC into TCS through thermal conversion;

FIG. 2 is a perspective view of a hermetic container for thermal conversion reaction according to a first exemplary embodiment;

FIG. 3 is an exploded perspective view of the hermetic container for thermal conversion reaction according to the first exemplary embodiment;

FIG, 4 is a front cross-sectional view of the hermetic container for thermal conversion reaction according to the first exemplary embodiment;

FIG. 5 is a plan cross-sectional view of the hermetic container for thermal conversion reaction according to the first exemplary embodiment;

FIG. 6 is a partial cut-open perspective view of a hermetic container for thermal conversion reaction according to a second exemplary embodiment;

FIG. 7 is a partial exploded perspective view of the hermetic container for thermal conversion reaction according to the second exemplary embodiment;

FIG. 8 is a front cross-sectional view of the hermetic container for thermal conversion reaction according to the second exemplary embodiment;

FIG. 9 is a perspective view of a hermetic container for thermal conversion reaction according to a third exemplary embodiment;

FIG. 10 is an exploded perspective view of the hermetic container for thermal conversion reaction according to the third exemplary embodiment;

FIG. 11 is a front cross-sectional view of the hermetic container for thermal conversion reaction according to the third exemplary embodiment;

FIG. 12 is an enlarged view of an “A” part in FIG. 11;

FIG. 13 is a cross-sectional view of a spraying nozzle in a hermetic container for thermal conversion reaction according to another exemplary embodiment; and

FIG. 14 is a cross-sectional view of a hermetic container for thermal conversion reaction according to a forth exemplary embodiment.

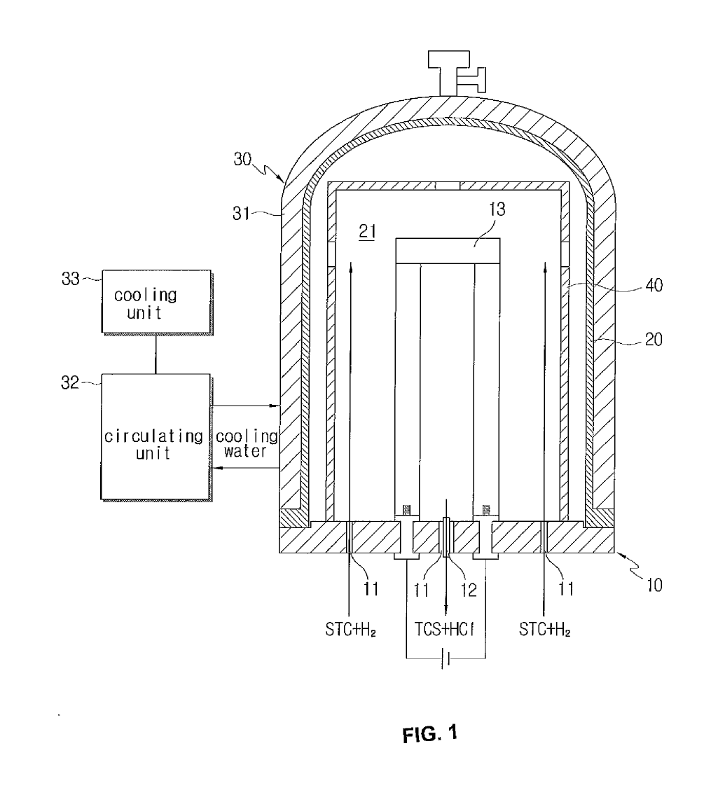

### DETAILED DESCRIPTION OF THE EMBODIMENTS

Prior to description, elements will be representatively explained in a first embodiment and only different configurations will be described in another embodiment, in which like reference numerals refer to like elements throughout the embodiments.

Hereinafter, a hermetic container for thermal conversion reaction according to exemplary embodiments will be described with reference to accompanying drawings.

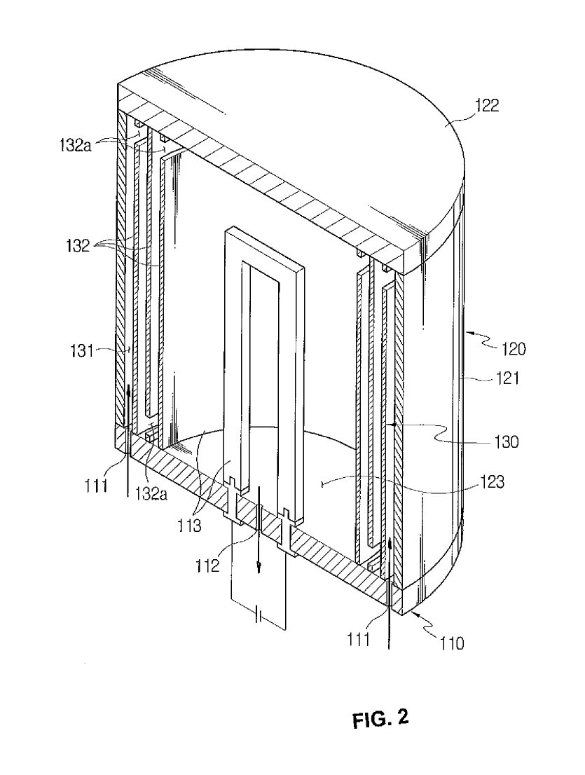

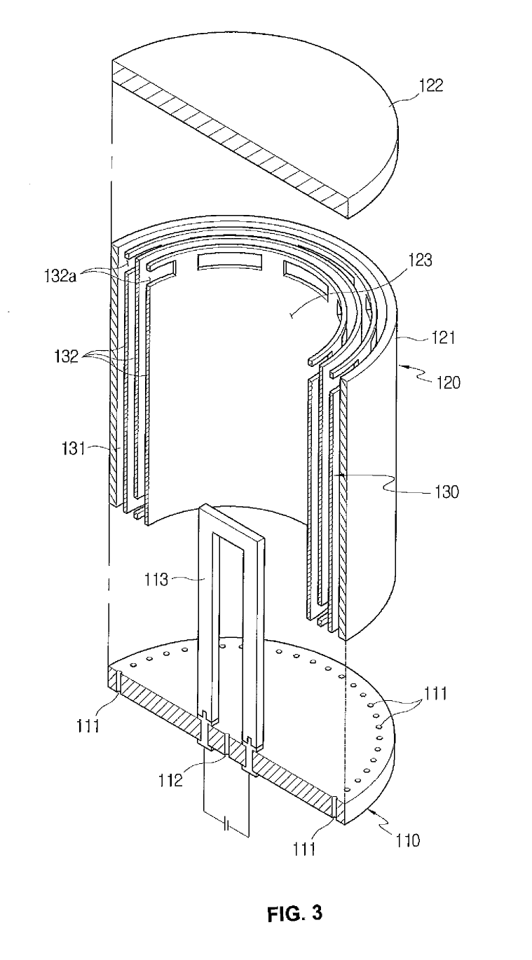

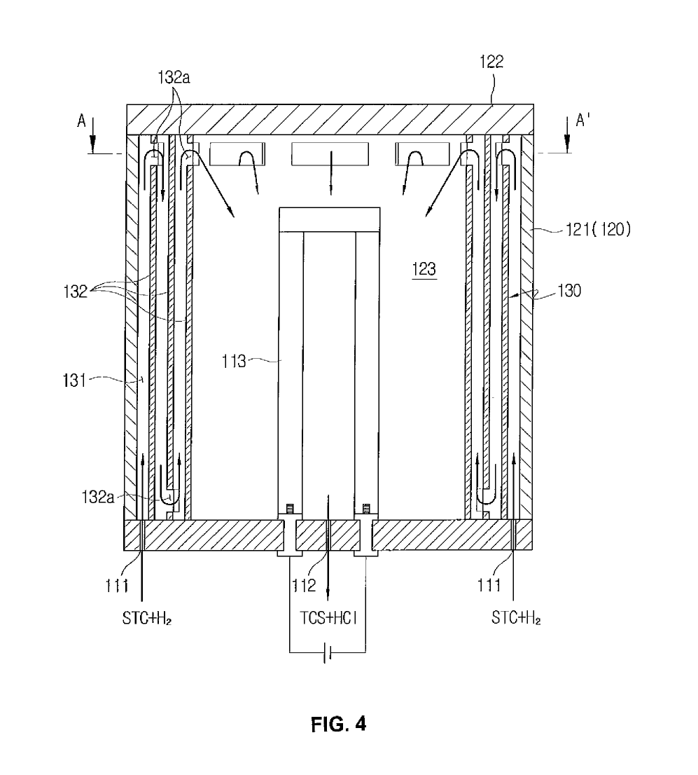

Among the accompanying drawings, FIG. 2 is a perspective view of a hermetic container for thermal conversion reaction according to a first exemplary embodiment, and FIG. 3 is an exploded perspective view of the hermetic container for thermal conversion reaction according to the first exemplary embodiment.

As shown therein, the hermetic container for thermal conversion reaction according to the first exemplary embodiment includes a base plate 110, a vessel 120, and a heat exchanger 130 provided on a side of the vessel 120. In this exemplary embodiment, the hermetic container for thermal conversion reaction will be for example described as an STC-TCS converter that converts silicon tetrachloride (SiCl₄, hereinafter referred to as ‘STC’) into trichlorosilane (SiHCl₃, hereinafter referred to as ‘TCS’).

The base plate 110 is formed with an outlet hole 112 at the center thereof, and a plurality of inlet holes on the outer circumference thereof. Further, a heater 113 for generating heat when powered on is installed on the top of the base plate 110.

The vessel 120 is assembled to the base plate 110 so as to form a hot zone 123 sealed from an exterior region. In this exemplary embodiment, the vessel 120 includes a side wall 121 and a cover 122 covering an upside of the side wall 121.

The heat exchanger 130 is formed on an inner side of the side wall 121 of the vessel 120 so that the reaction gas (STC+H₂) introduced through an inlet hole 111 of the base plate 110 can absorb thermal energy from the side wall 121 of the vessel 120 and be supplied to the hot zone 123 as it is heated. The heat exchanger 130 includes a circulating passage 131 connecting the inlet hole 111 with the hot zone 123.

In the present exemplary embodiment, cylindrical partition walls 132 different in a diameter from one another are concentrically arranged, and through holes 132a are alternately formed between one end part and the other end part of respective partition walls 132 with regard to positions of the inlet holes 111, so that the circulating passage 131 can be arranged in a zigzag fashion.

That is, the reaction gas introduced into the circulating passage 131 through the inlet hole 111 positioned between the outer partition wall 132 among the plural partition walls 132 and the side wall 121 of the vessel 120 circulates zigzag in a space between the partition walls 132 via the through holes 132a of the partition walls 132. Thus, the reaction gas absorbs thermal energy transferred to the vessel 120 and the partition wall 132, so that the reaction gas supplied to the hot zone can be heated with thermal energy that may not only heat the vessel 120 but also escape to the outside of the vessel 120, thereby improving efficiency of thermal energy utilization.

In the foregoing exemplary embodiment, the circulating passage 131 forms a zigzag passage as the through holes 132a of the partition walls 132 are misaligned with one another, but not limited thereto. Alternatively, any type of structure may be configured as long as it can increase a heat exchanging area or a heat exchanging time by branching or changing a moving path while the reaction gas moves along the circulating passage.

Also, in the case where the plurality of partition walls 132 are provided as above, thermal energy transferred to the partition wall 132 is varied depending on positions where the partition walls 132 are provided, i.e., distances from the heater, so that the respective partition walls 132 can be heated at different temperatures. For example, if the hot zone 123 has a temperature of about 1200° C. and the reaction gas supplied via the inlet hole 111 has a temperature of 80° C., the side wall 121 keeps a temperature of about 200° C. or under, and the partition walls 132 from the partition wall 132 facing the side wall 121 to the partition wall 132 facing the hot zone 123 are respectively heated at temperatures of about 300° C., 500° C. and 700° C. Therefore, the plurality of partition walls 132 have to be configured with materials having thermal resistances respectively corresponding to the temperatures heated at arranged positions.

Also, the plural inlet holes 111 of the base plate 110 are provided at neighboring intervals in order to supply the reaction gas having equal pressure with respect to a horizontal direction in a space between the vessel 120 and the outmost partition wall 132.

Further, the drawings show that the through hole 132a is formed by penetrating the partition wall 132, but not limited thereto. Alternatively, the through hole may be given in various forms for communicating both side spaces of the partition wall 132 with each other. For example, one end part of the partition wall 132 may be coupled to the base plate 110 or the cover 122, and the other end part may be spaced apart at a predetermined space from the cover 122 or the base pate 110, thereby using the space as the through hole.

In the foregoing exemplary embodiment, the vessel 120 includes the side wall 121 and the cover 122, but not limited thereto. Alternatively, in the case of a bell-jar type vessel, the heat exchanger 130 provided inside the vessel 120 may include a partition wall 132 that has a shape corresponding to the inside of the vessel 120, i.e., the same shape as the vessel 120 and spaced apart at a predetermined distance from the inside of the vessel 120. In this case, the partition wall 132 may be arranged in plural and the through hole 132a may be formed to be misaligned with each other, thereby enhancing a thermal exchanging efficiency of the circulating passage 131.

Now, operations of the foregoing hermetic container for thermal conversion reaction will be described according to the first exemplary embodiment.

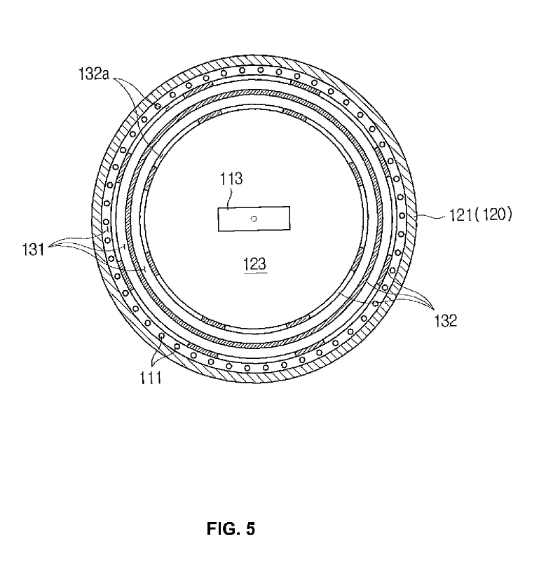

FIG. 4 is a front cross-sectional view of the hermetic container for thermal conversion reaction according to the first exemplary embodiment, and FIG. 5 is a plan cross-sectional view of the hermetic container for thermal conversion reaction according to the first exemplary embodiment.

First, as shown in FIG. 4, the side wall 121 of the vessel 120 is arranged on the outer circumference of the base plate 110, and the cover 122 is arranged on the top of the side wall 121, thereby forming the hermetic hot zone 123. Then, the heater 113 provided on the base plate 110 is powered on and heats the hot zone 123 to have an internal temperature of about 900° C. to 1500° C. proper to the reaction.

In the state that the internal temperature of the hot zone 123 is raised as above, if STC and H2 are supplied through the inlet holes 111 of the base plate 110, they are converted into TCS and HCl by thermal hydrogenation in the hot zone 123 and thus TCS and HCl are discharged through the outlet holes 112.

At this time, the heat exchanger 130 is provided inside the side wall 121 of the vessel 120 and cools the side wall 121 surrounding the hot zone 123 by the circulating passage 131 connecting the inlet hole 111 and the hot zone 123 and at the same time raises the temperature of the reaction gas supplied to the hot zone 123.

Particularly, the circulating passage 131 is formed by the partition walls 132 that has the bottom coupled to the base plate 110 between the inlet holes 111 and the heater 113, the top coupled to the cover 122, and the through hole 132a formed on the surface thereof and allowing the both side spaces to communicate with each other. The through holes 132a are alternately formed between one end part and the other end part of the partition wall 132 with respect to the inlet holes 111, so that the inlet holes 111 and the hot zone 123 can be connected in a zigzag fashion.

The reaction gas introduced into the circulation passage 131 via the inlet holes 111 absorbs the thermal energy transferred to the vessel 120 and the partition wall 132 and cools the vessel 120 so that it can be supplied to the hot zone 123 as it is heated at the same time.

Thus, there is no need of a separate cooling system for cooling the vessel 120, and loss of the thermal energy escaping to the outside of the vessel 20 is prevented, thereby offering an advantage of improving efficiency in thermal energy utilization.

Also, the reaction gas absorbs the thermal energy transferred to the side wall 121 of the vessel 120 and is thus supplied to the hot zone 123 as it is heated, so that not only the efficiency in thermal energy can be improved but also the power consumption of the heater 113 for maintaining the hot zone 123 to have a temperature proper to the reaction can be decreased.

Also, the circulating passage 131 is formed in a zigzag fashion by the through holes 132a alternately arranged between one end parts and the other end parts of the plural partition walls 132 with respect to the inlet holes 111, thereby increasing a heat exchanging area between the reaction gas introduced into the circulating passage 131 via the inlet holes 111 and the vessel 120 and between the reaction gas and the partition wall 132.

FIG. 5 shows a cross-section taken along line A-A′ of FIG. 4. As shown therein, the inlet holes 111 penetrating the outer circumference of the base plate 110 and positioned between the side wall 121 and the outer partition wall 132 are arranged in plural at regular intervals along the circumferential direction, so that the reaction gas can be introduced via the respective inlet holes 111 and supplied to the hot zone 123 through the circulating passage 131.

Here, the inlet holes 111 are densely arranged at equal intervals, so that the reaction gas can be evenly supplied by equal pressure with regard to the whole area of the inlet side of the circulating passage 131. Also, the reaction gas moves up or down by equal pressure with respect to the horizontal direction in each region of the circulating passage 131, thereby preventing the side wall 121 and the partition walls 132 from rapidly increasing in temperature at a certain region.

Then, a hermetic container for thermal conversion reaction will be described according to a second exemplary embodiment.

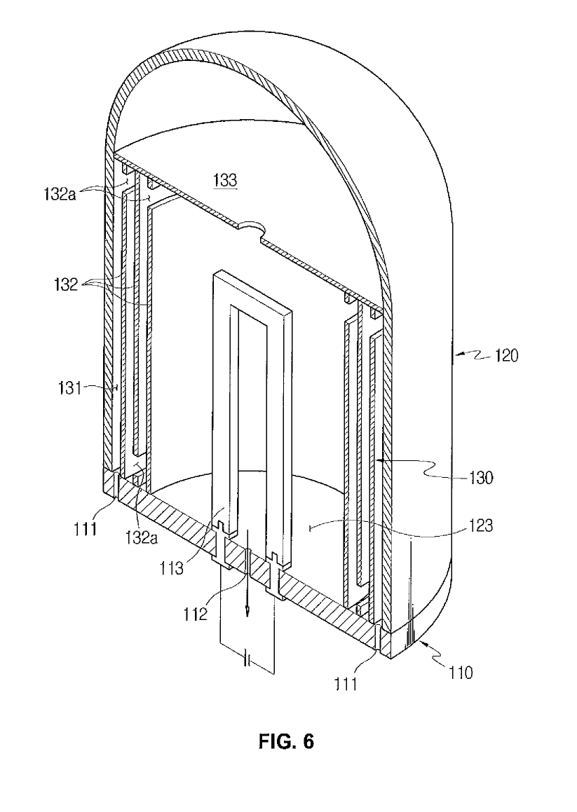

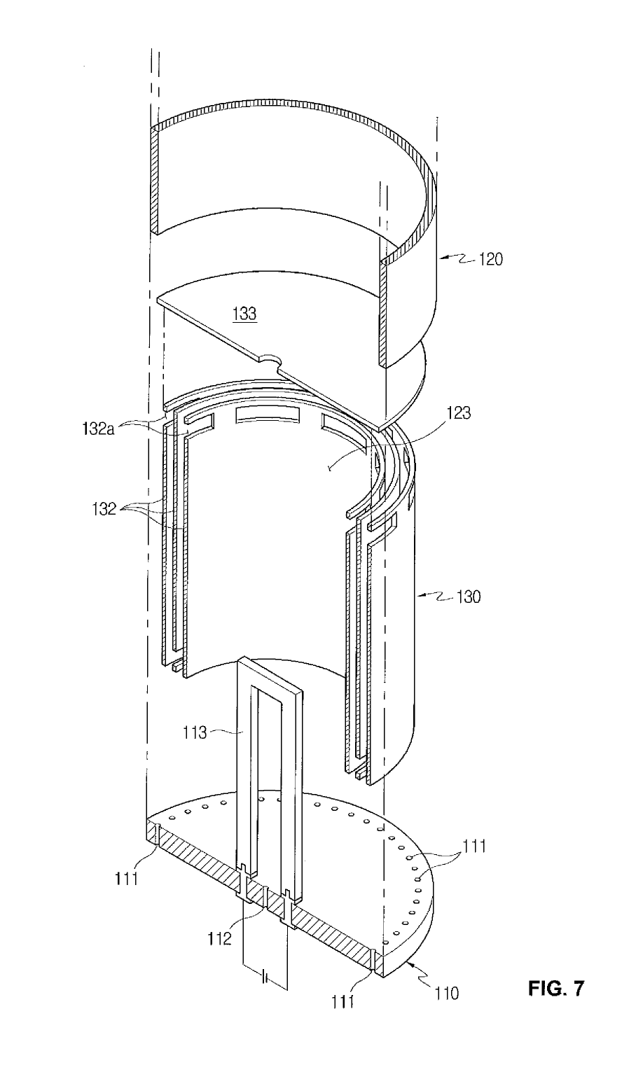

Among the accompanying drawings, FIG. 6 is a partial cut-open perspective view of the hermetic container for thermal conversion reaction according to the second exemplary embodiment, and FIG. 7 is a partial exploded perspective view of the hermetic container for thermal conversion reaction according to the second exemplary embodiment.

As shown therein, in the hermetic container for thermal conversion reaction according to the second exemplary embodiment, the vessel 120 is a bell-jar type opened at one side, and the opened side is assembled to the base plate 110, thereby internally forming a hot zone.

Also, the circulating passage 131 of the heat exchanger 130 provided inside the vessel 120 and connecting the inlet holes 111 and the hot zone 123 includes at least one cylindrical partition wall 132 arranged between the inlet holes 111 of the base plate 110 and the heater 113, the through hole 132a formed at an end part opposite to the inlet holes 111 on the surface of the partition wall 132, and the cover 133 having an outer circumference to be adhered to the inside of the vessel 120 and covering the top of the cylindrical partition wall 132.

To improve the thermal exchanging efficiency of the circulating passage like the above-described exemplary embodiment, the plural cylindrical partition walls different in a diameter from one another may be provided, and the through holes formed on the respective partition walls may be alternately arranged with respect to the inlet holes, thereby forming a zigzag moving path (see FIG. 6).

Meanwhile, the other elements except the vessel and the heat exchanger are the same as those of the foregoing exemplary embodiment, and thus repetitive descriptions thereof will be avoided as necessary.

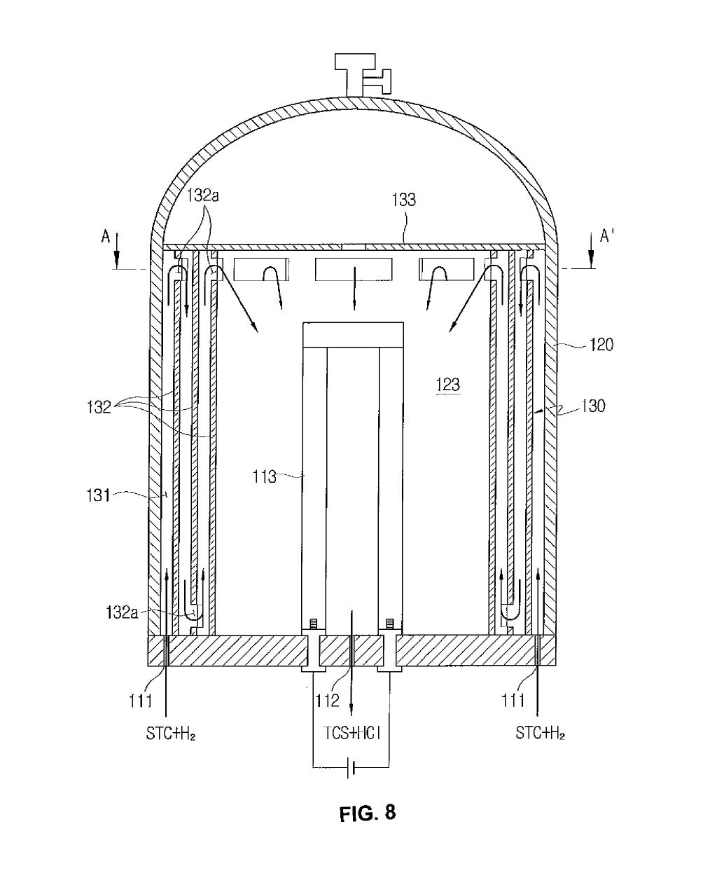

Among the accompanying drawings, FIG. 8 is a front cross-sectional view of the hermetic container for thermal conversion reaction according to the second exemplary embodiment.

As shown in FIG. 8, the heat exchanger 130 includes an upwardly opened cylindrical partition wall 132 arranged between the inlet holes 111 of the base plate 110 and the bell-jar type vessel 120, the through hole 132a formed at a position spaced part from the inlet holes 111 on the surface of the partition wall 132 and allowing both side spaces to communicate with each other, and the cover 133 covering the top opened side of the partition wall 132 and having an outer circumference to be adhered to the inside of the vessel 120.

Also, the plurality of partition walls 132 are different in size from one another, and divides a space between a space having opposite end parts supported by the cover 133 and the base plate 110 and including the inlet holes 111 adjacent to the inside of the vessel 120 and a space including the outlet holes 112 and the heater 113 into a plurality of layers. At this time, the plurality of partition walls 132 is formed with the through holes 132 at alternate positions with respect to the inlet holes 111, so that the circulating passage 131 connecting the inlet hole 111 and the hot zone 123 can be formed in a zigzag fashion.

That is, in the state that the heat exchanger 130 is arranged inside the vessel 120 surrounding the hot zone 123, the reaction gas is supplied via the inlet holes 111 to the hot zone 123 at the evaporation temperature of STC very lower than a temperature of about 900° C. to 1500° C. maintained in the hot zone 123. At this time, since the reaction gas absorbs the thermal energy transferred to the vessel 120 and the partition wall 132 while passing through the zigzag circulating passage 131 connecting the inlet holes 111 and the hot zone 123, there is no need of the conventional separate cooling system for cooling the vessel 120.

Further, the reaction gas supplied at the evaporation temperature of STC very lower than the temperature of the hot zone 123 is supplied to the hot zone 123 as it is heated up to a temperature of about 500° C. to 500° C. while passing through the circulation passage 131 of the heat exchanger 130, thereby preventing the temperature of the hot zone 123 from being rapidly lowered by the introduction of the reaction gas. Therefore, it is possible to additionally reduce the power consumption of the heater 113.

Meanwhile, as described above, the number of partition walls 132 constituting the circulating passage 131 may be adjusted in consideration of the temperature of the reaction gas supplied to the hot zone 123, loss of thermal energy escaping to the outside of the vessel 120, thermal exchanging efficiency based on the material of the partition wall 132, etc.

Below, a hermetic container for thermal conversion reaction according to a third exemplary embodiment will be described in detail with reference to accompanying drawings.

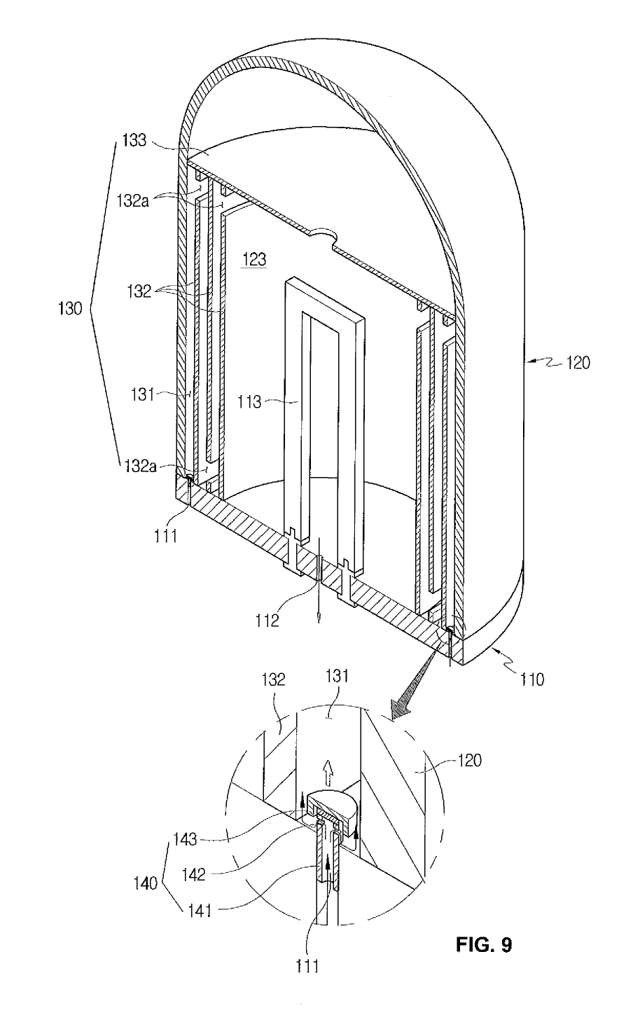

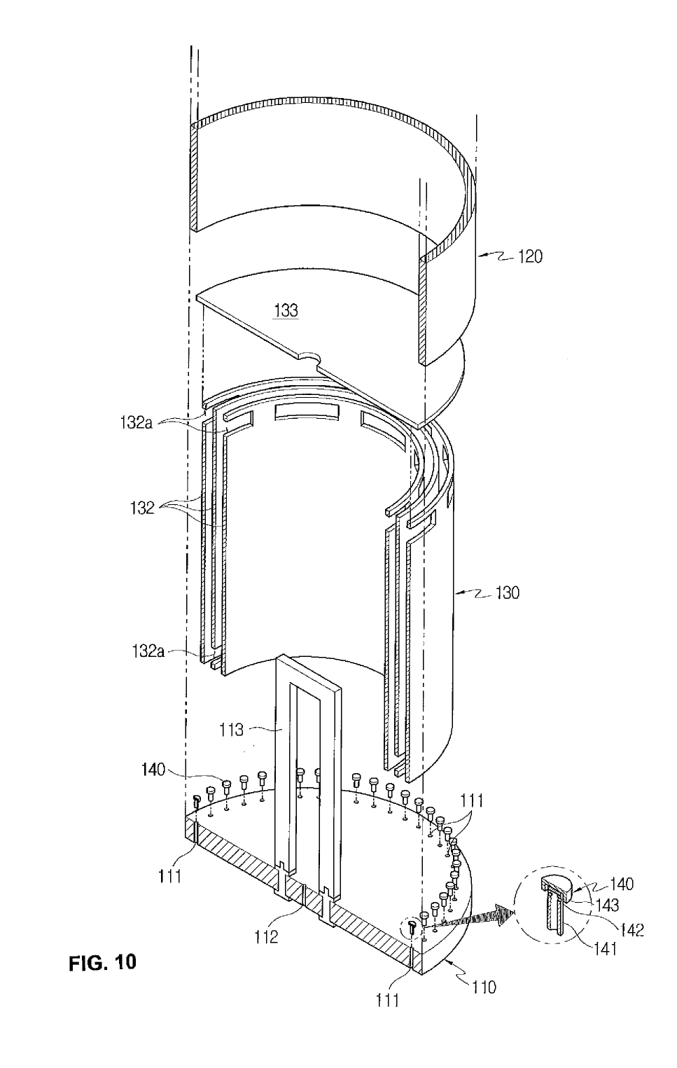

Among the accompanying drawings, FIG. 9 is a perspective view of the hermetic container for thermal conversion reaction according to the third exemplary embodiment, and FIG. 10 is an exploded perspective view of the hermetic container for thermal conversion reaction according to the third exemplary embodiment.

As shown therein, the hermetic container for thermal conversion reaction according to the third exemplary embodiment includes the base plate 110, the vessel 120, the heat exchanger 130 and a spraying nozzle 14. This exemplary embodiment is the same as the foregoing exemplary embodiments except that the spraying nozzle 140 is provided in the inlet hole 111 of the base plate 110, and thus repetitive descriptions thereof will be avoided as necessary.

The spraying nozzle 140 is provided in a gas discharging side of the inlet hole 111 and disperses a spraying direction of the reaction gas. The spraying nozzle 140 includes one end part coupled to the inlet hole 111 and the other end part that has a finished supplying pipe 141, at least one spraying hole 142 laterally formed at the other end part of the supplying pipe 141 and allowing the reaction gas to be discharged, and a guide 143 spaced apart at a predetermined distance from the spraying hole 142 so that the reaction gas laterally sprayed through the spraying hole 142 can be guided downward.

From now on, operations of the hermetic container for the thermally conversion reaction according to the third exemplary embodiment will be described.

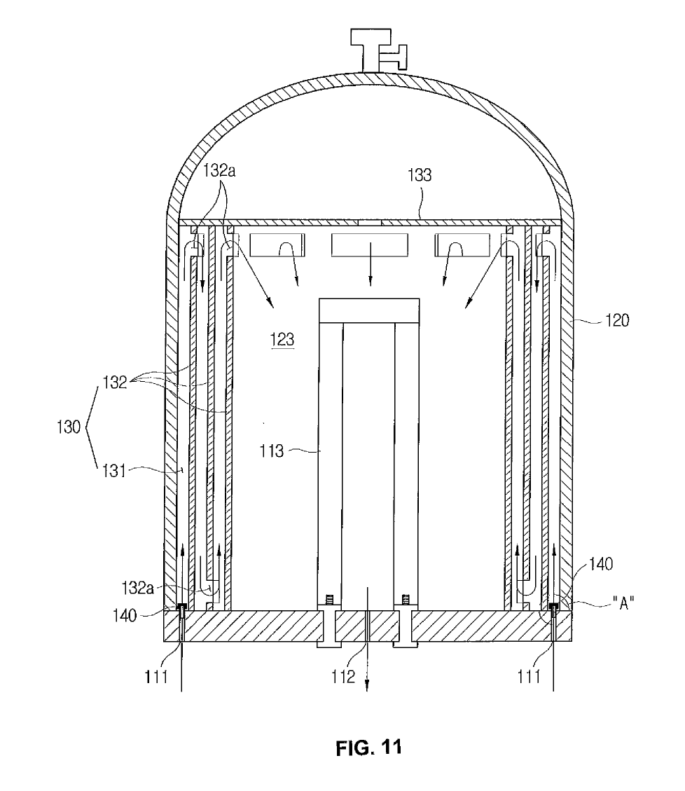

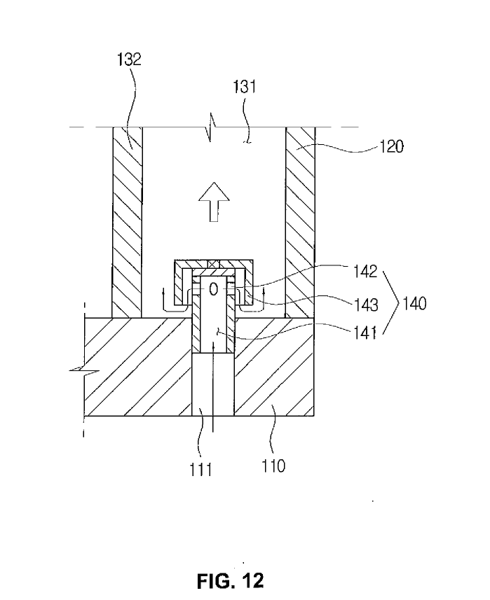

Among the accompanying drawings, FIG. 11 is a front cross-sectional view of the hermetic container for thermal conversion reaction according to the third exemplary embodiment, and FIG. 12 is an enlarged view of an “A” part in FIG. 11.

First, as shown in FIG. 11, the circulating passage 131 connecting the inlet holes 111 and the hot zone 123 is formed by the heat exchanger 130 arranged inside the vessel 120.

Further, the plurality of partition walls 132 constituting the heat exchanger 130 and the through holes 132a formed on the partition walls 132 cause the circulating passage 131 connecting the inlet holes 111 and the hot zone 123 to form a zigzag moving path.

In this state, the reaction gas introduced via the inlet holes 111 at the evaporation temperature of STC very lower than the temperature of the hot zone 123 absorbs the thermal energy transferred to the vessel 120 and the partition wall 132 while passing through the zigzag circulating passage 131, and is then supplied to the hot zone 123 as it is heated.

Particularly, the spraying nozzles 140 are respectively coupled to the discharging sides of the inlet holes 111 and disperse the reaction gas supplied to the circulating passage 131 of the heat exchanger 130 via the inlet hole 111, thereby preventing the spraying pressure from being focused on a certain region. Also, the reaction gas is sprayed downward in the circulating passage 131, so that heat exchange can be performed while the reaction gas is supplied even to a region between the adjacent spraying nozzles, thereby improving the efficiency in thermal exchange.

That is, the reaction gas supplied via the inlet holes 111 are respectively discharged from the supplying pipe 141 of the spraying nozzle 140 arranged in the gas discharging side of the inlet hole 111 and from the plurality of spraying holes 142 laterally formed at the other end part of the supplying pipe 141, thereby dispersing supply pressure. Also, the guide 143 provided at a position spaced apart at a predetermined distance from the spraying hole 142 guides the reaction gas to be sprayed toward the bottom of the base plate 110.

Accordingly, the reaction gas moves by equal pressure until reaching an upper region from a lower region of the circulating passage 131, so that time to absorb thermal energy from the partition wall 131 and the vessel 120 can be extended. Further, the heat exchange is performed while the reaction gas changed in a supply direction from the both spraying nozzles 140 is supplied even between the adjacent spraying nozzles 140, thereby offering an advantage of improving the efficiency of thermal conversion.

Next, another exemplary embodiment of the spraying nozzle in the hermetic container for thermal conversion reaction will be described.

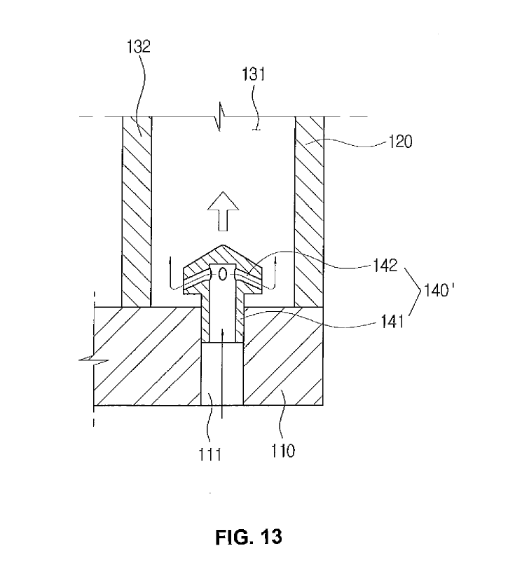

Among the accompanying drawings, FIG. 13 is a cross-sectional view of a spraying nozzle in a hermetic container for thermal conversion reaction according to another exemplary embodiment.

As shown therein, a spraying nozzle 140′ in this exemplary embodiment is different from the spraying nozzle 140 of the foregoing exemplary embodiment in that one end part is connected to the inlet hole 111 and the other end part includes a finished supplying pipe 141, and at least one spraying hole 142 downwardly inclined from the other end part of the supplying pipe 141 and discharging the reaction gas.

If the reaction gas is supplied via the inlet holes 111 in the state that the spraying nozzle 140′ with this configuration according to this exemplary embodiment is arranged at a gas discharging side of the inlet hole 111 positioned between the vessel 120 and the partition wall 132, the reaction gas is discharged downward in the circulating passage 131 through the plurality of spraying holes 142 inclined downward at the other end part of the supplying pipe 141 of the spraying nozzle 140′

At this time, the reaction gas can be sprayed in various directions since there are the plural spraying holes 142, and supplied downward in a lower region of the circulating passage 131 because the spraying hole 142 is inclined downward. Therefore, the reaction gas evenly moves to an upper region by pressure focused on the lower region of the circulating passage 131, thereby prolonging time to absorb thermal energy transferred to the partition wall 132 and the vessel 120. Further, the reaction gas is supplied to even a space between a pair of adjacent spraying nozzles 140′, the heat exchange is performed in the whole region between the partition wall 132 and the vessel 120. Thus, this exemplary embodiment offers an advantage of improving the thermal exchanging efficiency.

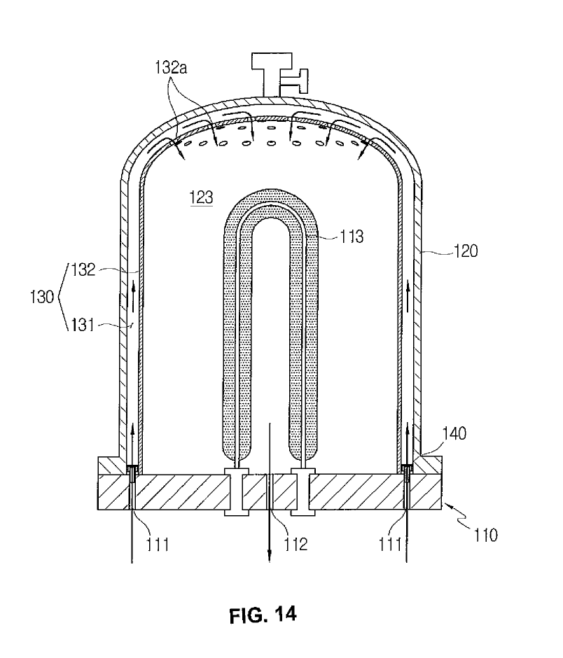

Among the accompanying drawings, FIG. 14 is a cross-sectional view of a hermetic container for thermal conversion reaction according to a forth exemplary embodiment. In this exemplary embodiment, the hermetic container for thermal conversion reaction will be for example described as a chemical vapor deposition (CVD) reactor for producing highgrade purity polycrystalline silicon.

As shown in FIG. 14, the hermetic container for thermal conversion reaction according to the fourth exemplary embodiment includes the base plate 110, the vessel 120, the heat exchanger 130 and the spraying nozzle 140.

Here, the heater 113 provided on the base plate 110 may include a seed filament that resistively generates heat when receiving electric power and induces silicon to be deposited on an outer surface thereof.

Also, the circulating passage 131 of the heat exchanger 130 is arranged to surround the heater 113 and the outlet hole 112, and includes a bell-jar type partition wall 132 partitioning a space involving the heater 113 and the outlet hole 112 and a space involving the inlet hole 111 and adjacent to the inside of the vessel 120, and the through hole 132a formed on the partition wall 132 at an opposite side to the inlet hole 111.

The other elements except the heater 113 and the circulating passage 131 are the same as those of the foregoing exemplary embodiments. Also, the spraying nozzle 140 installed at a part marked with “A” in FIG. 14 is also provided in the same form as the spraying nozzle 140 of FIG. 13 and the spraying nozzle 140′ of FIG. 14, and thus repetitive descriptions thereof will be avoided as necessary.

Operations of the hermetic container for thermal conversion reaction according to the fourth exemplary embodiment are as follows. The heater 113 is powered on and maintains its surface temperature of about 1100° C. as a typical reaction temperature. In this state, if the reaction gas (TCS+H₂) is supplied through the inlet hole 111, silicon ingredients of the reaction gas are deposited on the external surface of the heater 113, and hydrogen chloride 3HCl remaining after the reaction is discharged through the outlet hole 112.

At this time, the reaction gas supplied through the inlet hole 111 is introduced into a space between the partition wall 132 and the vessel 120 and not only absorbs the thermal energy transferred to the vessel 120 and the partition wall 132 while circulating along the moving path of the circulating passage 131 but also absorbs thermal energy transferred to the vessel 120 and the partition wall 132 while being supplied to the hot zone 123 via the through hole 132a spaced apart from the inlet hole 111.

Therefore, the reaction supplied at a temperature lower than the reaction temperature is supplied as it is heated, thereby reducing power consumption of the heater 113 for maintaining the hot zone 123 to have a high temperature. Also, the vessel 120 is cooled while the reaction gas absorbs the thermal energy transferred to the vessel 120 and the partition wall 132, thereby offering an advantage that there is no need of a separate cooling system provided outside the vessel 120 in order to cool the vessel 120, or the capacity or operation of the cooling system is minimized.

Further, the spraying nozzles 140 are respectively coupled to the discharging sides of the inlet holes 111, so that the supply pressure of the reaction gas supplied to the circulating passage 131 of the heat exchanger 130 via the inlet hole 111 can be dispersed and the reaction gas can be sprayed downward in the circulating passage 131. Thus, the heat exchange is performed while the reaction gas is supplied even to the lower region of the circulation passage 131 and a region between the pair of adjacent spraying nozzles, thereby improving the thermal exchanging efficiency.

As described above, there is provided a hermetic container for thermal conversion reaction, in which a vessel is prevented from being heated at a limit temperature or over, and thus there is no need of a separate cooling system for cooling the vessel since reaction gas is supplied to a hot zone as it is heated by absorbing thermal energy escaping to the outside of the vessel when the reaction gas is supplied to the hot zone.

Also, there is provided a hermetic container for thermal conversion reaction, in which the reaction gas is supplied to the hot zone as it is heated by absorbing thermal energy, so that not only the temperature of the hot zone can be prevented from being rapidly lowered, but also power consumption of a heater can be reduced.

Further, there is provided a hermetic container for thermal conversion reaction, in which a plurality of partition walls constituting a heat exchanger and a circulating passage connecting an inlet hole with the hot zone via a through hole formed in one end part or the other end part of the partition wall are arranged in a zigzag fashion, thereby enhancing a thermal exchanging efficiency.

Further, there is provided a hermetic container for thermal conversion reaction, in which a spraying nozzle is provided for dispersing spraying pressure of reaction gas at a gas inlet side of the circulating passage connecting the inlet hole and the hot zone and at the same time evenly supplying the reaction gas up to a region between the spraying nozzle and another spraying nozzle adjacent thereto.

Further, there is provided a hermetic container for thermal conversion reaction, in which heat exchange is carried out even in regions between plural spraying nozzles and a lower region of the circulating passage where the spraying nozzle is placed, thereby improving efficiency of heat exchange.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A hermetic container for thermal conversion reaction, comprising:
a base plate;
a vessel which, together with the base plate, forms a hermetic hot zone;
a heater which is arranged in the hot zone;
inlet and outlet holes through which reaction gas is supplied to and discharged from the hot zone; and
a heat exchanger which is provided inside the vessel so that the reaction gas supplied to the hot zone via the inlet holes can absorb thermal energy transferred to the vessel to cool temperature of the vessel and at the same time be supplied to the hot zone as being heated.

2. The hermetic container according to claim 1, wherein the heat exchanger comprises a circulating passage that circulates in a space between the vessel and the hot zone and connects the inlet holes and the hot zone.

3. The hermetic container according to claim 2, wherein the circulating passage comprises a partition wall partitioning a space involving the inlet holes and adjacent to an inside of the vessel and a space involving the heater and the outlet holes, and a through hole formed on the partition wall as being spaced apart from the inlet hole so that the reaction gas supplied via the inlet hole can be supplied to the hot zone after exchanging heat while circulating in a space between the partition wall and the vessel).

4. The hermetic container according to claim 3, wherein the partition wall is provided as two or more cylindrical shapes different in size so that a space between the space involving the inlet hole and adjacent to the inside of the vessel and the space involving the heater and the outlet hole can be partitioned into a plurality of layers, and is arranged such that a small partition wall is inserted in a large partition wall.

5. The hermetic container according to claim 4, wherein the through holes formed on the two or more partition walls are alternately arranged with respect to the inlet hole to change a moving path of the reaction gas.

6. The hermetic container according to claim 5, wherein the partition wall is shaped like a cylinder having an opened top, and the hermetic container further comprises a cover finishing the tops of the partition walls and having an outer circumference adhered to the inside of the vessel.

7. The hermetic container according to claim 6, wherein the partition wall comprises a material having thermal resistance to temperature raised by thermal energy transferred from the hot zone at a arranged position.

8. The hermetic container according to claim 1, further comprising a spraying nozzle provided at a gas discharging side of the inlet hole and dispersing gas supplied to the heat exchanger.

9. The hermetic container according to claim 8, wherein the plural inlet holes are formed at predetermined intervals on the base plate corresponding to a region between the partition wall and the vessel.

10. The hermetic container according to claim 9, wherein the spraying nozzle comprises one end part connected to the inlet hole and receiving gas, and the other end part comprising a finished supply pipe, and at least one spraying hole laterally formed from the supplying pipe and discharging gas.

11. The hermetic container according to claim 10, wherein the spraying nozzle comprises a guide spaced apart from the spraying hole and guiding the laterally sprayed gas to be induced downward.

12. The hermetic container according to claim 11, wherein the spraying nozzle comprises one end part connected to the inlet hole and receiving gas, and the other end part comprising a finished supply pipe, and at least one spraying hole inclined downward from the supplying pipe and discharging gas.

13. The hermetic container according to claim 5, further comprising a spraying nozzle provided at a gas discharging side of the inlet hole and dispersing gas supplied to the heat exchanger.

14. The hermetic container according to claim 13, wherein the plural inlet holes are formed at predetermined intervals on the base plate corresponding to a region between the partition wall and the vessel.

15. The hermetic container according to claim 14, wherein the spraying nozzle comprises one end part connected to the inlet hole and receiving gas, and the other end part comprising a finished supply pipe, and at least one spraying hole laterally formed from the supplying pipe and discharging gas.

16. The hermetic container according to claim 15, wherein the spraying nozzle comprises a guide spaced apart from the spraying hole and guiding the laterally sprayed gas to be induced downward.

17. The hermetic container according to claim 16, wherein the spraying nozzle comprises one end part connected to the inlet hole and receiving gas, and the other end part comprising a finished supply pipe, and at least one spraying hole inclined downward from the supplying pipe and discharging gas.
